(19) United States
(12) Patent Application Publication
(10) Pub. No.: US 2011/0318722 A1
(43) Pub. Date: Dec. 29, 2011

(54) METHOD AND SYSTEM FOR CAREER INTEGRATED ONLINE LEARNING

(76) Inventor: S. Giridharan, Chennai (IN)

(21) Appl. No.: 12/998,717

(22) PCT Filed: Nov. 26, 2009
(86) PCT No.: PCT/IN09/00684

§ 371 Date: Aug. 12, 2011

Related U.S. Application Data
(60) Provisional application No. 61/193,415, filed on Nov. 26, 2008.

(51) Int. Cl. G09B 3/00

(52) U.S. Cl. 434/322

(57) ABSTRACT

An online system enrolls students and manpower resources and connects to a suitable careers based on their back-ground, skills and choices and provides appropriate learning with appropriate assessments to connect/map suitable careers to the student while learning. Allows clients to provide requirements along with related position specifications to compare, check, and engage resources for a position. Provides automated learning content with metrics including interactive automated assessments to train resources to make them ready for the particular job and engaged, should there be a requirement to undergo training as part of the requirement. Education centers having multimedia based PCs are connected to a centralized system having a database and application that connects a student, requirements, and client to impart learning before the resource is allocated to the position. Secured network is deployed with a centralized software to seamlessly deliver training, job engagement and allocation, fee based registration and enrollment, and assessments.

### BACKGROUND OF THE INVENTION

The present invention relates to the field of online learning and more specifically on career stream focused and linked learning. Here the career stream is more relevant to the desired target as aimed by a resource to get placed at every stage of their career right from the school as primary and secondary leading to pre-university studies to advanced career growth in a senior job position. The existing online learning systems provide for sharpening the skills of the applicant. The present method integrates the career stream and provides for the specific skills to be updated in order to fit the career stream requirement more relevant and matching to one's own background and interests in a particular domain. The invention also provides for a system, which connects various entities like a client (industry), a (human) resource, a franchise partner and an education center.

### SUMMARY OF THE INVENTION

The present invention provides a method and system for online learning, which is focused and linked to a particular career stream for every such learning entity, in a fully automated system called Humanware Education And Deployment System (HEADS).

In one embodiment the invention consists of a system of learning which includes a centralized server, which is connected through a network to a resource and to a client. The server data is hosted by the HEAL (Heads Learning Content) Labs and is central to the whole network.

In another embodiment the invention provides a method of learning, which integrates the client and a resource in a way that the resource fits into the client's requirement perfectly without having to undergo any post recruitment training.

In another embodiment the invention provides a method of learning, which trains and links a resource at every stage of their career to a targeted industry or a client or a targeted accreditation or a degree accomplishment or an achievement index recognized globally.

In another embodiment of the invention the learning system comprises of a central distribution process control called LAMPS(Learning, Assessment, Placement Management System) that provides a centrally controlled and automated learning and career mechanism that assures transparent and seamless collaboration to all benefiting communities viz., Industry/Client, Resource/Student, Partner/Franchisee, and school/Institution/College.

In another embodiment of the invention the method of online learning is operated by a partner-led center or an institution in-campus called EdCenter that connects to a HEADS office which promotes the brand and ensures partners sign-up in traditional franchisee way and do the business on a royalty based revenue model.

A method of integrated online learning and career stream comprising the steps of collecting resource requirements in various industries, screening and selecting of resource for the collected requirements, align a particular industry demand to a resource selected, providing adequate skills and on-the-job training for the selected resource, measuring the performance of the trained resource through assessments at equal intervals and storing all metrics related to the resource being trained and assessed and creating trained and industry vetted resource and linking the resource to fit to a particular industry requirement

In yet another embodiment the invention provides for a method wherein the employers or academicians or accreditation bodies are provided with an industry vetted or institution certified trained resource through career mapped education right from school level.

In yet another embodiment of the invention provides aligning the industry demand to a resource includes the step of mapping the interests of a resource to a most suitable industry domain, mapping the metrics of a resource to the industry domain and providing information on such mapped industry domain to the resource

In yet another embodiment of the invention provides the method integrating into the learning process the mapped industry domain to make the resource interested in that mapped domain, measuring the performance of the trained resource through assessments at predetermined stages and communicating to the industry all the performance metrics at the said stages of the resource in the mapped domain to the industry.

### BRIEF DESCRIPTION OF THE DRAWINGS

FIG. 1 depicts the current scenario of education and demand and supply of resources

FIG. 2 represents the five key cornerstones of the HEADS Business Model

FIG. 3 depicts the grid pointers of the HEADS Learning architecture

FIG. 4 broadly represents the D2J e-contents of the HEADS business model

FIG. 5 depicts the HEADS system

FIG. 6 illustrates a block diagram for the HEADS Model

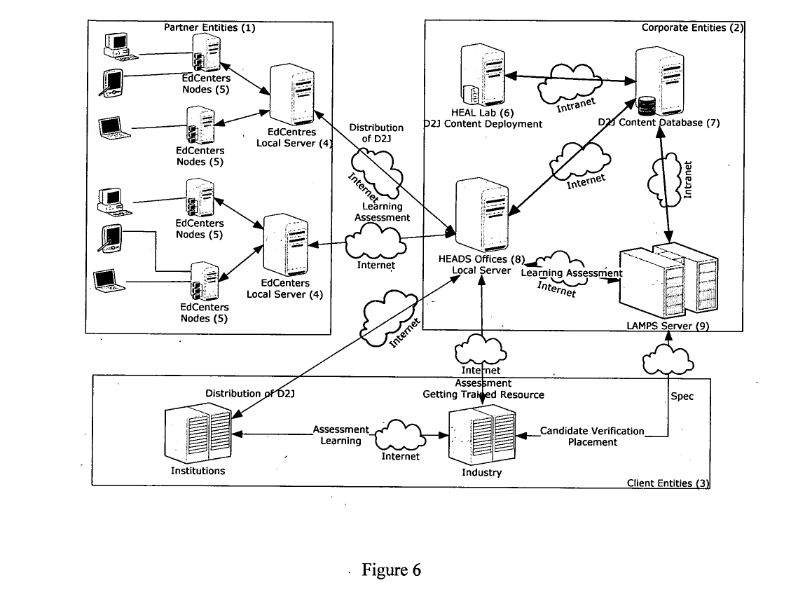

### DETAILED DESCRIPTION OF THE DRAWINGS

E-Learning is the mainstay in HEADS model's strategy in training volumes of fresh resources out of colleges to get placed in blue chip IT and non-IT companies. HEADS model envisaged the need of firm placement engagement for every resource that is getting trained either in-campus inside a college or in retail training centers. So the need for a new generation of education model with deployment as focus emerged. Thus the concept of HEADS model of Education & Deployment was born out of continuous research and development. One of the embodiments of the present invention is the birth of the new generation of the education model with a focus on employability and engagement with client as a mandatory requirement. Thus this is launched as the world's first 4th Generation Education model.

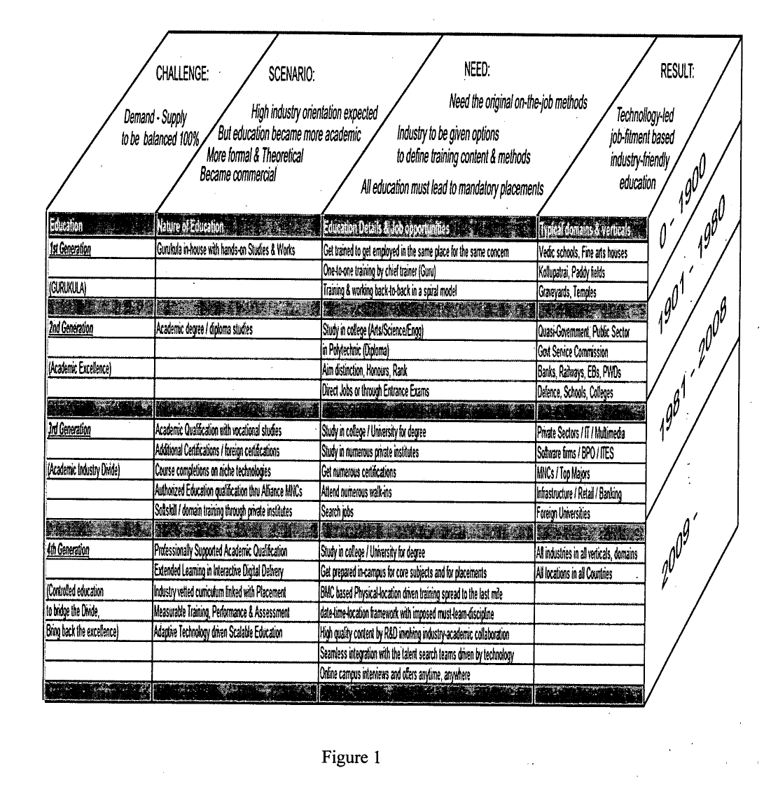

Education has evolved into generations. Prior to 4th Generation, the earlier ones including the current one lack a promise to provide a skill-matched career to a student based on a course. Current generation in particular generates more unemployment due to the way the demand and supply are split without a perfect match. (FIG. 1)

1st Generation being Gurukula type of on-the-job-learning with one-to-one trainer-student relationship; it is not scalable anymore

2nd Generation being Excellence in Education with high Demand and Low supply; it is no more applicable due to excess pool of resources

3rd Generation being the academy-industry divide as described above; needs a break

The present invention relates to a 4th Generation education model that has a definite job fitment for every aspirant who wishes to seek a career as a fresher. One of the embodiments of the invention is that the HEADS (Humanware Education and Deployment System) has education & deployment integrated as part of the business model and promises an industry vetted, job linked, assessment driven, resource mapped, and skill matched learning and career stream for every registrant.

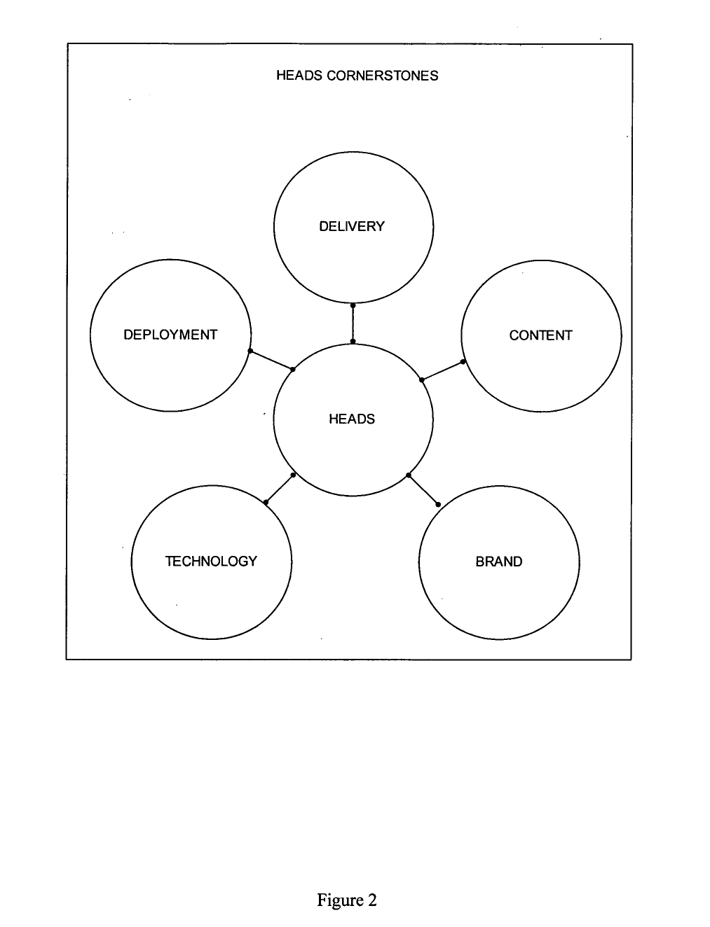

This next generation HEADS model consists of the following 5 key cornerstones (CS) (FIG. 2) to build and deliver centralized education to meet industry needs in terms of qualitative skills and scale through innovative use of tools and technology to seamlessly integrate training, fool-proof and transparent testing, metrics-based assessment and absorption of appropriately trained humanware.

1. CS1: Delivery: BMC and LAMPS Use of Brick and Mortar Centers' (BMC) driven approach for the last mile since the Indian psyche needs a date-time-location framework to impose the must-learn discipline required for learning; and a world-class Learning, Assessment, Placement Management System (LAMPS) to create efficiency in centralized delivery of technology-enabled content.
2. CS2: Content: HCI and IEC Development of technology enabled content using appropriate Human-Computer Interface (HCI) amenable for efficient remote delivery aided by high quality R&D and driven by Industry-Education Collaboration (IEC).
3. CS3: Technology: BCD and CSS Broad-band Content Delivery (BCD) just-in-time from a central Content Storage Subsystem (CSS) using the right combination of terrestrial and satellite linkages.
4. CS4: Deployment: MSR and SSA Linkage with the talent search teams at large corporations using a proprietary Manpower Search and Recruitment (MSR) workbench through a Seamless and Secure Access (SSA) for efficient stitching of need with demand for the trained pool of manpower.
5. CS5: Brand: PMD and Mascot Measurable performance using a Performance Monitoring Dashboard (PMD) and innovative marketing, centered around a trademark Mascot to build a strong brand.

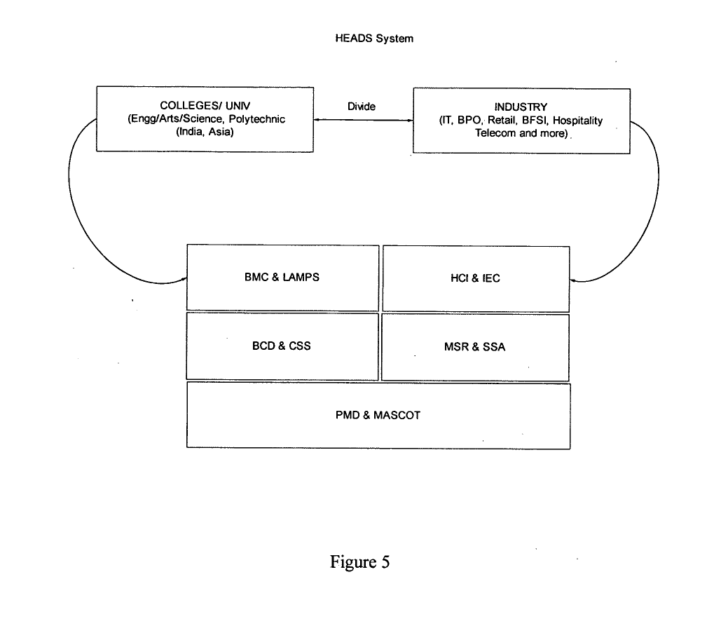

The HEADS model (FIG. 5) envisages web based automated learning driven by point-in-time assessment using industry vetted and job linked e-content called D2J (Degree-to-Job) content that is delivered through Brick-and-Mortar Centers (BMC) in a partner model so as to reach out all regions.

The design & development of the D2J is done by a centralized HEAL Lab as an e-plant with complete infrastructure to take up this activity of producing through outsourcing, monitoring, testing, installing and setting up, maintaining a distributable high volume e-content.

Content development involves designing & developing the SCORM compliant e-learning content using HEADS learning standards in over 25 IT and non-IT domains and verticals that include IT & ITES, Retail, BFSI (Banking, Financial Services, Insurance), Telecom, Manufacturing, Healthcare, and also all kinds of Academic disciplines that include Professional, Arts, Science as well as pre-university and senior secondary school streams.

HEAL (HEADS Learning) specifies the course management of the learning method through the LAMPS controlled way combining all interested communities: Partner, Student and Client and connecting all through broad-band Internet content delivery (BCD) with local contents stored and used through corporate digital secured handshake coding an decoding called Seamless and Secure Access (SSA). LAMPS is a distribution process control engine similar to a learning management system (LMS) which is the back-bone of the entire HEADS education and placement system that automates the entire process delivers all seamlessly in a scaled up business model.

The method also serves assessment and careers additionally apart from managing the learning. Assessment plays an important role in the method finding out the candidate's skill levels and competency to be integrated into a suitable career stream. Assessments are mostly automated and the metrics of a learning process is ploughed back into the next learning session, HEAL Lab houses the centralized back-bone high-end server system which shall have the central repository of all data as well as control information and LAMPS back-end for all EdCenters and the HEADS Centers. A BMC (Brick-and-Mortar Center) specifies a partner-led center way of doing the training with students registering for a particular batch to complete a course within a specified timeframe and denotes every EdCenter as a concept. An Edcenter is a BMC center which admits students, schedules batches, facilitates job fitment, and completes all courses successfully, manages business, collects revenue and shares with corporate. The HEAL Lab server capacity is directly proportional to the average number of courses that are in action and also the average number of centers and students that are in action which are rather controlled by the staff on-board in this lab.

HEADS offices are the regional controllers of the partner-led EdCenters where students enroll for a definite career stream fitment. The HEADS Centers also have a local data repository in a server system to more effectively service and support the EdCenters in terms of job offers, batch coordination, HEAL Content delivery coordination, EdCenter server check and control, student performance check, placement link check and control with industry, Client coordination and so on. HEADS offices are all controlled by a Corporate HEADS Center.

HEADS offices shall grow based on the number of EdCenters in a region in 1:20 ratio. The distribution and control is facilitated by a central high-end server system through a centralized distribution process control engine called LAMPS as the back-end in a HEADS center with a support team. LAMPS controls the learning, assessment, and placement of the resources who enroll at various EdCenter seamlessly using cutting-edge technology delivery and scrutiny. SMARTINSTANCES, SMARTCLARIFY, SPEAKNATIVE, SMARTSPEAK, SMARTFEED, CHECKLEARN are some of methodologies that LAMPS deploys using HEAL D2J content to successfully train and place a resource with Industry. LAMPS also has Micro, Session, and Final Assessment layers to assess and rightly assign students to a firm job fitment with a back-to-back arrangement with clients based on a vetted curriculum by them. Delivery of these e-learning contents is facilitated by the infrastructure of the partner-led center called EdCenter which connect to a HEADS office.

In yet another embodiment the HEAD (Humanware Education And Deployment) System has education & deployment integrated as part of the business model and promises an industry vetted, job linked, assessment driven, resource mapped, and skill matched learning and career stream for every registrant.

The HEADS model envisages web based automated learning driven by point-in-time assessment using industry vetted and job linked e-content called D2J (Degree-to-Job) content that is delivered through Brick-and-Mortar Centers (BMC) in a partner model so as to reach out all regions. The LAMPS is the distribution process control engine which is the Learning, Assessment, Management, System. It provides a centrally controlled and automated learning and placement mechanism that assures transparent and seamless collaboration to all benefiting communities viz., Industry/Client, Resource/Student, Partner/Franchisee, and Institution/College. LAMPS is central to the whole functioning of HEADS model that consistently maps and links every resource to a placement through highly validated and scrutinized process.

An EdCenter is a HEADS model center of the system. EdCenter (Education & Deployment Center) is a technology center having systems connected to the central repository and driven in a tightly integrated and secured network to a central software system called LAMPS. Each EdCenter is capable of generating an offer letter for a student right inside and provides the vital link to the industry for the student. Each course that a student undergoes inside EdCenter is out of a job linked, industry vetted, assessment driven curriculum and the student does the course with a full purpose of landing in a targeted placement engagement. The EdCenter is partner based model center of the main e-learning system.

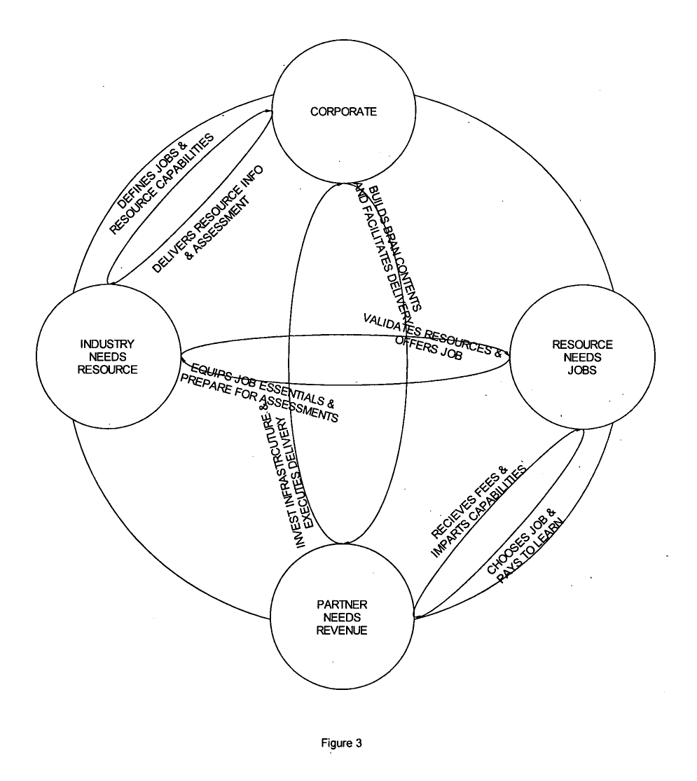

The HEADS Learning architecture (HEAL) (FIG. 3) tightly and seamlessly integrates the key Grid Pointers namely the Student (Resource), Industry (Client), Franchisee (Partner)/Institution (College) together with CORPORATE so as to deliver industry-ready resources picked up right from academics. A student as a resource has a strong desire for a targeted career stream; so is the industry having strong desire to recruit fresh resource in large volumes; the facilitator here is the Partner/Franchisee who has a strong desire to generate business without becoming answerable for the career stream. So the HEADS Grid essentially connects all these back-to-back such that every Grid Pointer's desire is fed by the other's need.

The present method combines several e-learning standards to make a unique and evolving model of learning called HEAL (HEADS Learning). It is web based offline content with the job fitment as focus. Today's simple e-learning interface is for a corporate employee who is paid to learn. But HEADS learning is for a student who pays to get recruited by a client and so is thoroughly customized. Learning for assessment and career stream is the focus. Learning through D2J content is simpler with concepts like SMARTINSTANCES and SMARTCLARIFY. All technical and advanced concepts are explained through real life situations called SMARTINSTANCES in the web learning content. Language barriers, understanding barriers, self-learning barriers are handled better in our model through another trademarked concept called SPEAKNATIVE. HEAL follows e-learning paradigm for the generic modular and component based content making.

Thus all industries are addressed for their resource requirements with the corresponding niche skills, let that be sales, support, or specific domain skills. Under HEAL architecture, every content that is developed and implemented must follow the architecture guidelines. Usually, the content what is prepared technically is raw in format by an SME (Subject Matter Expert). Subsequently, the Instructional Designer (ID) and the Graphics Designer (GD) shall visualize and convert the content into a HEAL content with D2J framework using a STORYBOARD. The same shall get approved and then the HEAL content shall be constructed into an e-content to be viewed in system. Following are the guidelines of HEAL for SME to make the raw content:

### Career Integrated Learning Content Guidelines

Subject Matter Experts (SME) make the raw content of the material. One should keep in mind the following points while making the content:
1. Raw content is the base for the entire material. The quality of the final output lies in the quality of the raw content which depends on the SME's understanding level of our content model, adherence to the standards and delivering the expected quality.
2. The quality of the raw content should be such that there are minimal review points to rework.
3. HEADS Learning material is different from other E-Learning contents, CBTs etc. It has its own structure and presentation standards.
4. The content should be prepared for a live class room session.
5. The language and flow should be such that the student sitting in front is directly addressed and he vicariously participates in the class.
6. The language should be simple, easy to understand and to the point.
7. There should not be any explicit reproduction from other available materials and the presentation should be original.
8. A lot of analogy based illustrations should be incorporated so that the student is able to relate the idea much more easily and the quality of learning is very high.
9. The subject should not be syntax based but concept based. It should be ensured that on taking up the course the student is able to apply what he has studied.
10. Contents are further fine tuned by Instruction Designer (ID) who visualizes the session along with the required teaching aids.
11. ID, on going through the raw content, decides on various parts of the presentation—Viz, the On-Screen Text, Graphics, Animation, Video or Audio part, the audio transcript and so on. ID interacts with the Creative Team in production of the actual material.
12. The content, apart from the actual subject matter, should also contain instructions to ID which will assist better understating and visualization of the session.
13. Assessments shall follow the sessions and they shall have the following components:
   a. MAL—Micro Assessment Layer
   b. SAL—Session Assessment Layer
   c. FAL—Final Assessment Layer
14. Assessments shall be intuitive and induce enough interest for a candidate to attempt to learn clearly the concepts; every learning session shall be supported by assessments.
15. Learning content shall reflect industry domains and verticals more and more to induce interest in a candidate to their background based subjects. Learning shall also map the candidate's skills and nature to a suitable career stream so that a candidate understands the type of domain to look at by going through the content as part of the learning process.
16. Career mapping is provided by seeding industry exposure into a resources mind at their early stage of education at schools. Further, this invention also provides a mechanism by which the outcome of assessments ploughs back the candidate's learning levels into the next learning session in order to understand the grasping levels and interest levels of every student.

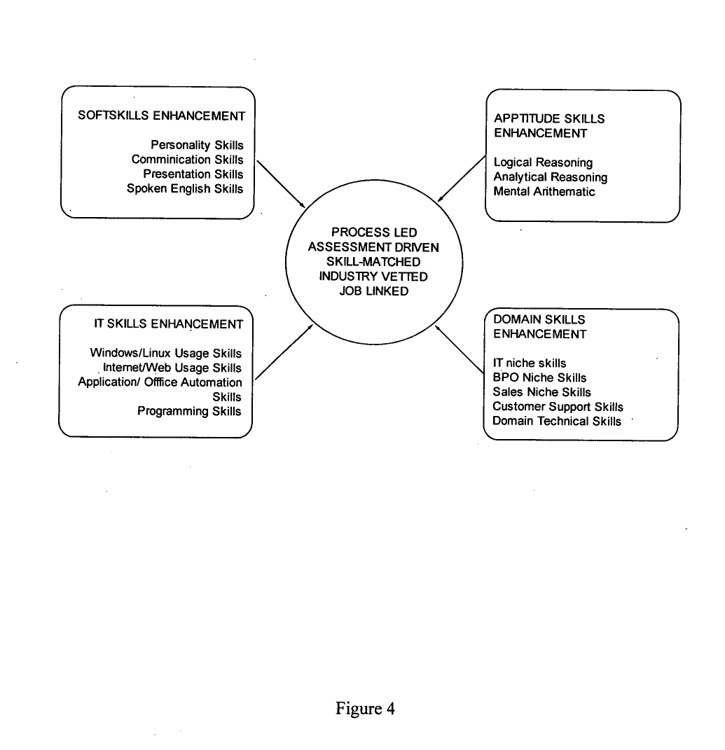

The D2J e-content of HEADS model (FIG. 4) envisages skill development by a customized content tightly integrated with assessment as vetted by industry directly. The HEADS model insists on mandatory job fitment for every course with the industry that has vetted the curriculum and has given the assessment. Due to this fact, the content necessarily covers the basic requirements of today's and tomorrow's industry in terms of an overall skill development of a fresher so as to be job ready. Soft skills, Aptitude Skills, Generic IT skills form part of every such training requirement in a job linked specification of an industry. Thus the content elevates every such aspirant who undergoes the course, from Degree TO a Job. The ever-growing gap between academics and industry is bridged once for all with automated offline web based learning with assessment to ensure every aspirant for a placement is registered with a firm assignment and also a course. On completing the course successfully and securing the required grades, the job is automatically allotted to him based on his skill levels, capability, background and thus all industries are addressed in terms of their requirement for a trained and employable professional in both IT and non-IT nature.
integrated into the learning process the mapped industry domain to make the resource interested in that mapped domain,
measuring the performance of the trained resource through assessments at equal intervals and
communicating the performance of the resource in the mapped domain to the industry.

E-learning contents deliver good results in terms of career stream orientation in every such student consistently across all regions. As a result, industries prefer such professional and proof-of-concept contents rather than look for manual training which may not be scalable and interoperable.

There is a great demand for fresh resources in non-IT domains and verticals apart from IT and ITES. Lack of qualified trainers and teaching faculty at those niche verticals both at academic and at vocational institutions make these urgent requirements for such qualified professionals to force industries to spend a lot of money and effort on mismatched recruitments. The HEADS model ensures that these industries spend only 20% of their efforts, time and money and grab such well qualified resources on touch of a key.

1. A system for online education for at least one student to spend a specified amount of time learning a course or connecting to a client for a career engagement on a particular HEADS (Humanware Education And Deployment System) model, the said system comprising a multiplicity of Partner Entities (1), a Corporate Entity (2), a number of Client Entities (3) being Institutions and Industries wherein all the said entities are interconnected on a network.

2. A system as claimed in claim 1 wherein a HEADS model comprises of a Delivery system, a Content driven by Industry-Education Collaboration, a combination of broadband, terrestrial, and satellite linkage and Deployment through a Seamless and Secure Access (SSA)

3. A system as claimed in claim 1 wherein a Partner Entity comprises of a number of EdCenter Local Servers (4) and EdCenter Nodes (5)

4. A Corporate Entity (2) as claimed in claim 1 comprising a HEAL (HEADS Learning) Lab (6), D2J Content Database (7), HEADS Office Local Server (8), LAMPS Server (9) capable of interacting on the internet for Distribution of D2J and assessment.

5. A system as claimed in claim 1 wherein the client entities comprises of schools/Institutions/colleges related to the HEADS learning and Industries with requirement for trained resource.

6. A system as claimed in claim 2 wherein the EdCenter Local Servers comprises of an education provider.

7. A system as claimed in claim 2 wherein the education provider comprises of a D2J (Degree to Job) content.

8. A method of integrated online learning and career stream comprising the steps of
collecting resource requirements in various industries,
screening and selecting of resource for the collected requirements,
align a particular industry demand to a resource selected,
providing adequate skills and on-the-job training for the selected resource,
measuring the performance of the trained resource through assessments at equal intervals and storing all metrics related to the resource being trained and assessed and creating trained and industry vetted resource: and
linking the resource to fit to a particular industry requirement

9. A method as claimed in claim 8 wherein the career stream engagement or assignment is done upon a condition to a student resource along with the targeted career stream pre-requisites which is a course/training content

10. A method as claimed in claim 8 wherein the initial screening happens through a Pre-Career Assessment (PCA) test which is automated based on the specifications of the industries for a position; the background is also checked for base credentials for the job and along with the PCA result, the matching of the resource capabilities with the requirement is done before the job is engaged.

11. A method as claimed in claim 8 wherein the Deployment of resource is performed through the candidate registering on to the EdCenter centers and opting for the required HEADS based job domains.

12. A method as claimed in claim 8 wherein the registration process includes creating system recognizable identification means to validate the authenticity of the candidate.

13. A method as claimed in claim 8 wherein assessment is performed on basis of the nature and skill levels of a candidate to prepare and position a suitable career stream

14. The method as claimed in claim 13 wherein after the assessment the metrics of a learning process is ploughed back into the next learning session

15. The method as claimed in claim 8 wherein aligning the industry demand to a resource includes the step of
mapping the interests of a resource to a most suitable industry domain
mapping the metrics of a resource to the industry domain
providing information on such mapped industry domain to the resource

16. The method as claimed in claim 15 comprises the steps of
integrating into the learning process the mapped industry domain to make the resource interested in that mapped domain,
measuring the performance of the trained resource through assessments at predetermined stages and
communicating to the industry all the performance metrics at the said stages of the resource in the mapped domain to the industry.
